(19) United States
(12) Patent Application Publication
(10) Pub. No.: US 2012/0155477 A1
(43) Pub. Date: Jun. 21, 2012

(54) MULTI HOP ROUTING APPARATUS AND MULTI HOP ROUTING METHOD

(75) Inventors: Young Hwan CHOI, Daejeon (KR); Jeong Il YIM, Daejeon (KR); Jun Seob LEE, Daejeon (KR); Sang Keun YOO, Daejeon (KR); Yong Woon KIM, Daejeon (KR); Hyoung Jun KIM, Daejeon (KR)

(73) Assignee: ELECTRONICS AND TELECOMMUNICATIONS RESEARCH INSTITUTE, Daejeon (KR)

(21) Appl. No.: 13/328,052

(22) Filed: Dec. 16, 2011

(30) Foreign Application Priority Data
Dec. 16, 2010 (KR) 10-2010-0129524

(51) Int. Cl. H04L 12/56

(52) U.S. Cl. 370/400

(57) ABSTRACT

Disclosed is a multi hop routing apparatus, including: a receiving unit that receives multi hop routing messages; a parsing unit that parses the received multi hop routing messages; and a control unit that performs a control to determine a routing path using a hop count value and a link quality indicator (LQI) value included in the parsed multi hop routing message.

### CROSS-REFERENCE TO RELATED APPLICATIONS

This application claims priority to and the benefit of Korean Patent Application NO. 10-2010-0129524 filed in the Korean Intellectual Property Office on Dec. 16, 2010, the entire contents of which are incorporated herein by reference.

### TECHNICAL FIELD

The present invention relates to a demand-based multi hop routing apparatus and a demand-based multi hop routing method.

### BACKGROUND

A demand-based multi hop routing method is a method that can provisionally set a routing path between transmitting and receiving nodes only when data to be transmitted and received between wireless mobile nodes are generated and reduce unnecessary energy waste by not managing corresponding information any more when data transmission ends.

However, since the demand-based multi hop routing method developed up to now is not appropriately developed to meet sensor network characteristics, the routing method may be inefficient for a sensor network. That is, a multi hop routing method capable of efficiently exchanging information between sensor nodes in consideration of resource characteristics of the sensor nodes is urgently needed.

### SUMMARY

The present invention has been made in an effort to provide a routing method appropriate for a sensor network. In particular, the present invention has been made in an effort to provide a routing method capable of using a hop count value mixed with a link quality indicator.

An exemplary embodiment of the present invention provides a multi hop routing apparatus, including: a receiving unit that receives multi hop routing messages; a parsing unit that parses the received multi hop routing messages; and a control unit that performs a control to determine a routing path using a hop count value and a link quality indicator (LQI) value included in the parsed multi hop routing message.

The multi hop routing message may include an item defining a message type, an item representing a total length of a message, an item representing the maximum number of hops, an item representing a link quality indicator, an item representing an address of an object node, an item representing an address of a source node, a sequence number item, and a hop count item representing the number of hops of the passing node.

The multi hop routing message may be any one of a route request (RREQ) message, a route reply (RREP) message, and a route error (RERR) message. The multi hop routing apparatus may further include: a memory that stores a routing table in which the hop count value and the link quality indicator value are included.

The control unit may perform a control to update the routing table using information included in the multi hop routing message when a sequence number included in the multi hop routing message is larger than a sequence number of the routing table.

The control unit may perform a control to update the routing table using the information included in the multi hop routing message when a value of the hop count item of the multi hop routing message is smaller than or equal to the hop count value of the routing table.

The receiving unit may sense signal strength at the time of receiving the multi hop routing message to derive the link quality indicator value, and the control unit may compare the sensed LQI value with the link quality indicator value included in the multi hop routing message to derive the minimum link quality indicator value.

The control unit may update the routing table using the minimum link quality indicator value when the minimum link quality indicator value is larger than the link quality indicator value included in the routing table.

The control unit may compare the hop count values on each routing path to perform a control to select the routing path having the small hop count when each minimum link quality indicator value on at least two routing paths is in a predetermined range.

The routing table may include an item representing an address of an object node, a next node address item on a path to the object node, a hop count item to the object node, and an item representing a minimum link quality indicator, the item including a smaller link quality indicator value as a result of comparing the link quality indicator value based on signal strength sensed at the time of receiving the multi hop routing message and the link quality indicator value included in the multi hop routing message.

Another exemplary embodiment of the present invention provides a multi hop routing method routing in a sensor node, including: receiving multi hop routing messages; parsing the received multi hop routing messages; setting a smaller value of link quality indicator values to a minimum link quality indicator value based on signal strength when receiving the link quality indicator (LQI) value included in the parsed multi hop routing message and the multi hop routing message; and setting a routing path using the minimum link quality indicator value when the minimum link quality indicator value is larger than the link quality indicator value included in a routing table on the sensor node.

The multi hop routing method may further include: determining whether the hop count value of the multi hop routing message is smaller than or equal to the hop count value of the routing table, wherein the setting may be performed if it is determined that the hop count value of the multi hop routing message is smaller than or equal to the hop count value of the routing table.

The setting may include: determining whether each minimum link quality indicator value on at least two routing paths is in a predetermined range when the minimum link quality indicator value is larger than a link quality indicator value included in the routing table on the sensor node; and selecting the routing path having a smaller hop count by comparing the hop count values on each routing path if it is determined that each minimum link quality indicator value on at least two routing paths is in a predetermined range.

According to exemplary embodiments of the present invention, it is possible to reduce the limited energy waste of the sensor node by providing the demand-based multi hop routing method appropriate for the sensor network. As a result, the exemplary embodiments of the present invention can more efficiently transmit data.

In particular, according to exemplary embodiments of the present invention, it is possible to minimize the power consumption by the efficient information exchange method in the low power sensor network including the low power radio sensor node.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIGS. 1A and 1B are diagrams for schematically explaining a multi hop routing apparatus and a multi hop routing method according to an exemplary embodiment of the present invention.

FIG. 2 is a block diagram showing a low power sensor node according to an exemplary embodiment of the present invention.

FIG. 3A is a diagram showing a data structure of a route request (RREQ) message used in a routing protocol according to an exemplary embodiment of the present invention and FIG. 3B is a diagram for explaining each item of the RREQ message according to an exemplary embodiment of the present invention.

FIG. 4A is a diagram showing a data structure of a route reply (RREP) message used in the routing protocol according to an exemplary embodiment of the present invention and FIG. 4B is a diagram for explaining each item of the RREP message according to an exemplary embodiment of the present invention.

FIG. 5A is a diagram showing a data structure of a route error (RERR) message used in a routing protocol according to an exemplary embodiment of the present invention and FIG. 5B is a diagram for explaining each item of the RERR message according to an exemplary embodiment of the present invention.

FIG. 6 is a diagram showing a configuration of a routing table according to an exemplary embodiment of the present invention.

FIG. 7 is a flow chart for explaining a method of transferring the RREQ message according to an exemplary embodiment of the present invention.

FIG. 8 is a flow chart for explaining a method of transferring the RREP message and the RERR message according to an exemplary embodiment of the present invention.

FIG. 9 is a flow chart for explaining the routing method according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art.

Exemplary embodiments of the present invention may be implemented by various means. For example, the exemplary embodiments of the present invention may be implemented firmware, software, or a combination thereof, or the like.

In the implementation by the hardware, a method according to exemplary embodiments of the present invention may be implemented by application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

In the implementation using the firmware or the software, a method according to exemplary embodiments of the present invention may be implemented by modules, procedures, functions, or the like, that perform functions or operations described above. Software codes are stored in a memory unit and may be driven by a processor. The memory unit is disposed in or out the processor and may transmit and receive data to and from the well-known various units.

Throughout the specification, a case in which any one part is “connected with” the other part includes a case in which the parts are electrically connected with each other with other elements interposed therebetween as well as a case in which the parts are directly connected with each other. Unless explicitly described to the contrary, the term “comprise” and variations such as “comprises” or “comprising” will be understood to imply the inclusion of stated elements but not the exclusion of any other elements.

A term “module” described in the specification means a single unit of processing a predetermined function or operation and can be implemented by hardware or software or a combination of hardware and software.

Predetermined terms used in the following description are provided to help understandings of the present invention. The use of the predetermined terms may be changed into other forms without departing from the technical idea of the present invention.

Hereinafter, exemplary embodiments of the present invention will be described in detail with reference to the accompanying drawings.

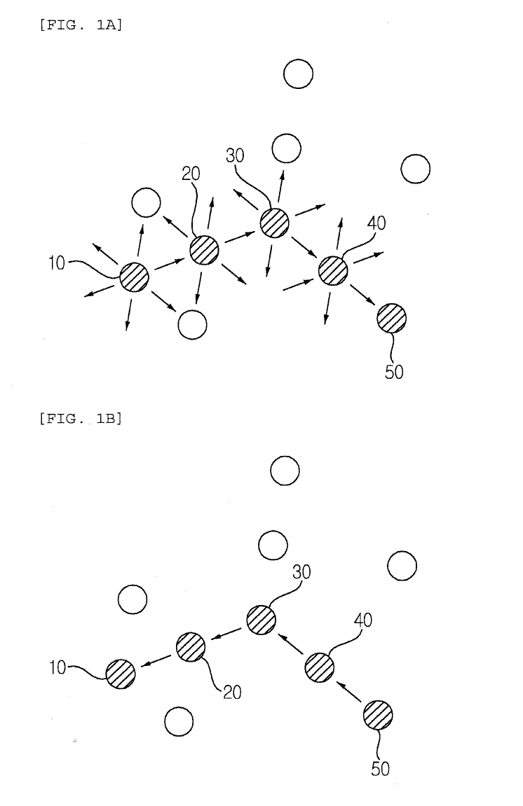

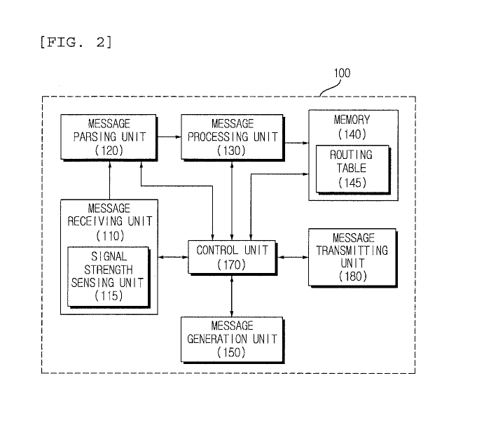

FIGS. 1A and 1B are diagrams for schematically explaining a multi hop routing apparatus and a multi hop routing method according to an exemplary embodiment of the present invention.

In the exemplary embodiment of FIGS. 1A and 1B, a node denoted by reference numeral 10 as a source node, nodes denoted by reference numerals 20, 30, and 40 as neighboring nodes, and a node denoted by reference numeral 50 as an object node are described by way of example.

In this configuration, a source node 10 is a node requesting a routing path to an object node 50.

According to the exemplary embodiment of FIG. 1A, the source node 10 generates an RREQ message and broadcasts the generated RREQ message to the neighboring nodes 20, 30, and 40 in order to set the routing path to the object node 50. The neighboring node 20 receives the RREQ message and again broadcasts the received RREQ message to the neighboring nodes. The object node 50 receives the RREQ message through the above-mentioned broadcasting process.

Meanwhile, according to the exemplary embodiment of FIG. 1B, the object node 50 receives the RREQ message from the source node 10 and then, generates the RREP message as a reply message and unicasts the generated RREP message to the source node 10. In this case, identifiers (IDs) of the neighboring nodes stored in each node will be used.

The routing path between the source node 10 and the object node 50 is set through transmission and reception of the RREQ message and the RREP message.

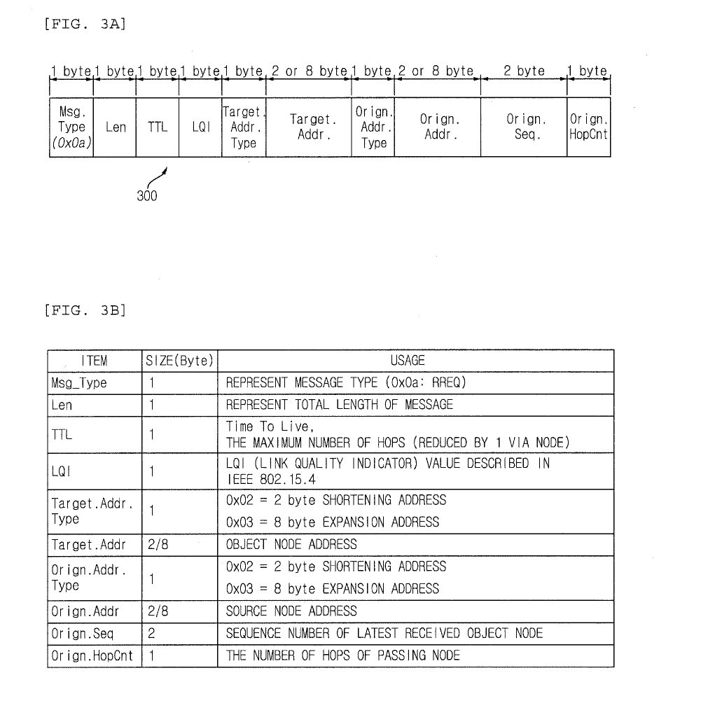

FIG. 2 is a block diagram showing a low power sensor node according to an exemplary embodiment of the present invention.

Hereinafter, the exemplary embodiment of the present invention will be described with reference to FIGS. 1 and 2.

A sensor node 100 according to the exemplary embodiment of the present invention includes a message receiving unit 110, a message parsing unit 120, a message processing unit 130, a memory 140, a memory generation unit 150, a message transmitting unit 180, and a control unit 170.

The message receiving unit 110 according to the exemplary embodiment of the present invention receives various messages transmitted from other nodes.

An example of various messages may include an RREQ message, an RREP message, and an RERR message, or the like, that will be described below.

In this case, the RREQ message is a message that is broadcast from the source node 10 in order to set the routing path from the source node 10 to the object node 50. The RREP message is a unicasting message that is transmitted from the object node 50 to the source node 10 as a reply to the received RREQ message after the object node 50 receives the RREQ message. The RERR message is a message that instructs the node searching link breakage to the source node 10 so as to again set the routing path.

Meanwhile, the message receiving unit 110 includes a signal strength sensing unit 115. The signal strength sensing unit 115 according to the exemplary embodiment of the present invention serves to sense the signal strength for various received messages. In this case, an example of a result of sensing the signal strength may include a received signal strength indicator (RRSI) value. The signal strength sensing unit 115 derives a link quality indicator (LQI) value based on the RRSI that is the result of sensing the signal strength. In this case, the LQI value means a value that quantitates the RSSI value as a 1 byte figure and has a higher value as the receiving sensitivity is good. The LQI value has a value generally between 50 and 120 at the time of actual measurement.

The message parsing unit 120 according to the exemplary embodiment of the present invention serves to parse various messages received through the message receiving unit 110.

The message processing unit 130 according to the exemplary embodiment of the present invention serves to receive various information in the parsed messages from the message parsing unit 120 and process the received various information.

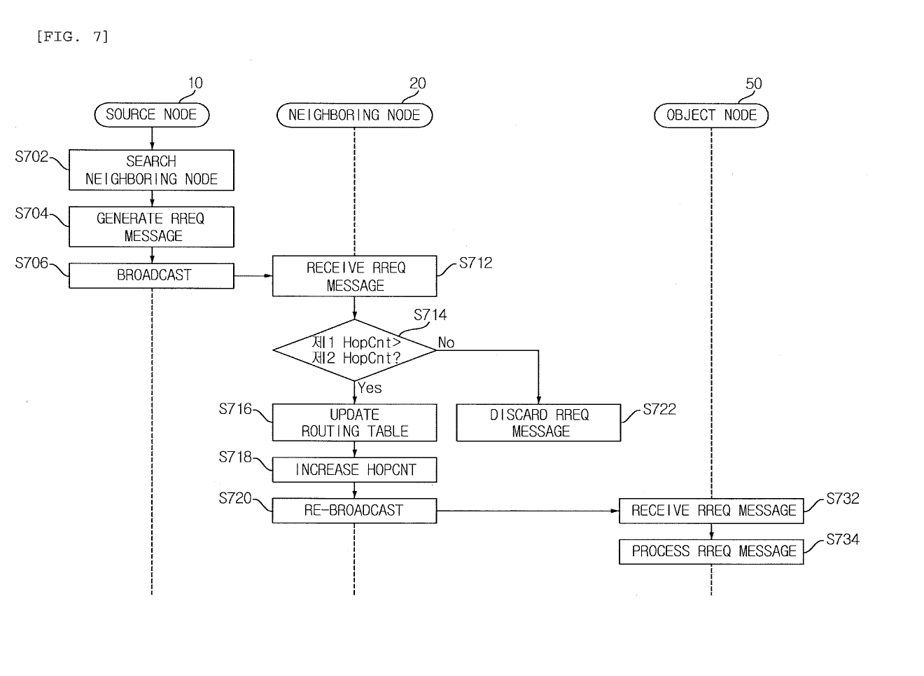

The memory 140 according to the exemplary embodiment of the present invention stores various information and various data that are required in the corresponding nodes. In particular, according to the exemplary embodiment of the present invention, the memory 140 stores a routing table 145 that includes items shown in FIG. 6. The memory 140 stores the identifiers (IDs) of each node.

The message generation unit 150 according to the exemplary embodiment of the present invention serves to generate the RREQ message, the RREP message, the RERR message, or the like, by referring to the routing table of the corresponding node, or the like.

The message transmitting unit 180 according to the exemplary embodiment of the present invention serves to transmit messages generated through the message generation unit 150 to other nodes.

The control unit 170 according to the exemplary embodiment of the present invention serves to control each operation of the message receiving unit 110, the message parsing unit 120, the message processing unit 130, the memory 140, the message generation unit 150, and the message transmitting unit 180.

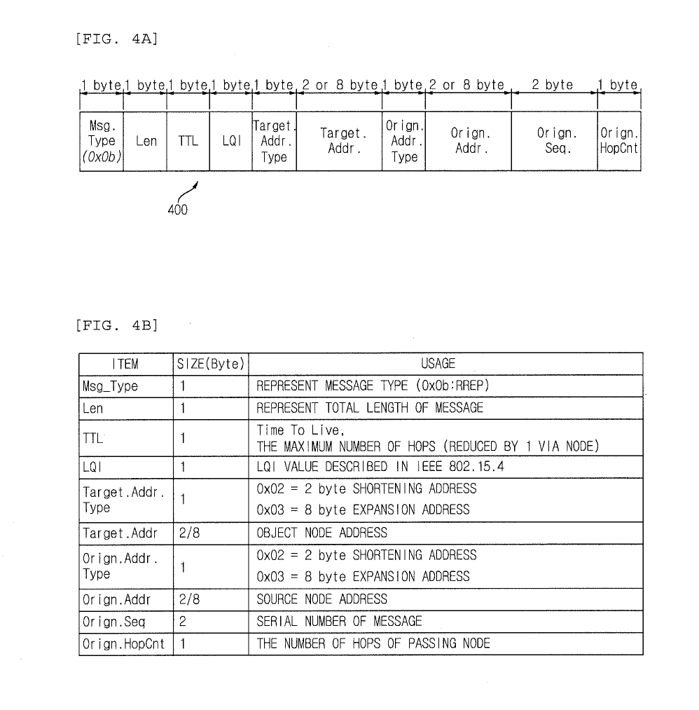

FIG. 3A is a diagram showing a data structure of a route request (RREQ) message used in a routing protocol according to an exemplary embodiment of the present invention and FIG. 3B is a diagram for explaining each item of the RREQ message according to an exemplary embodiment of the present invention.

As shown in FIG. 3A, an RREQ message 300 according to the exemplary embodiment of the present invention includes a Msg_Type item, a Len item, a TTL item, an LQI item, a Target.Addr.Type item, a Target.Addr item, an Orign.Addr.Type item, an Orign.Addr item, an Orign.Seq item, and an Orign.HopCnt item.

The Msg_Type item is allocated with 1 byte and represents a type of the corresponding message. In the case of the RREQ message according to the exemplary embodiment of the present invention, the present item represents 0x0a.

The Len item is allocated with 1 byte and represents a total length of the corresponding message.

The time to live (TTL) item is allocated with 1 byte and represents the maximum number of hops of the corresponding message. The TTL item is reduced by 1 every time the corresponding message passes through each node.

The LQI item is allocated with 1 byte and represents the link quality indicator (LQI) value. The exemplary embodiment of the present invention describes, for example, the LQI value described in IEEE 802.15.4, but is not limited thereto.

The Target.Addr.Type item is allocated with 1 byte and represents the address type of the object node. In the exemplary embodiment of the present invention, when the present item represents 0x02, the Target.Addr item represents a shortening address of 2 bytes and when the present item represents 0x03, the Target.Addr item represents the expansion address of 8 bytes.

The Target.Addr item is allocated with 2 bytes or 8 bytes and represents the address of the object node. When the Target.Addr.Type item represents 0x02, the Target.Addr item represents the object node address of 2 bytes. On the other hand, when the Target.Addr.Type item represents 0x03, the Target.Addr item represents the object node address of 8 bytes.

The Orign.Addr.Type item is allocated with 1 byte and represents the address type of the source node. In the exemplary embodiment of the present invention, when the present item represents 0x02, the Orign.Addr item represents a shortening address of 2 bytes and when the present item represents 0x03, the Orign.Addr item represents the expansion address of 8 bytes.

The Orign.Addr item is allocated with 2 bytes or 8 bytes and represents the address of the source node. When the Orign.Addr.Type item represents 0x02, the Orign.Addr item represents the source node address of 2 bytes. On the other hand, when the Orign.Addr.Type item represents 0x03, the Orign.Addr item represents the source node address of 8 bytes.

The origin.Seq item is allocated with 2 bytes and represents a sequence number of the latest received object nodes. The present item may also mean a sequence number of messages.

The Orign.HopCnt item is allocated with 1 byte and represents the number of hops of the neighboring nodes through which the RREQ message passes. The present item is increased by 1 every time the RREQ message moves from one node to another node

FIG. 4A is a diagram showing a data structure of a route reply (RREP) message used in the routing protocol according to an exemplary embodiment of the present invention and FIG. 4B is a diagram for explaining each item of the RREP message according to an exemplary embodiment of the present invention.

As shown in FIG. 4A, an RREP message 400 according to the exemplary embodiment of the present invention includes a Msg_Type item, a Len item, a TTL item, an LQI item, a Target.Addr.Type item, a Target.Addr item, an Orign.Addr.Type item, an Orign.Addr item, an Orign.Seq item, and an Orign.HopCnt item.

The Msg_Type item is allocated with 1 byte and represents a type of the corresponding message. In the case of the RREP message according to the exemplary embodiment of the present invention, the present item represents 0x0b.

The Len item is allocated with 1 byte and represents a total length of the corresponding message.

The time to live (TTL) item is allocated with 1 byte and represents the maximum number of hops of the corresponding message. The TTL item is reduced by 1 every time the corresponding message passes through each node.

The LQI item is allocated with 1 byte and means the LQI value. The exemplary embodiment of the present invention describes, for example, the LQI value described in IEEE 802.15.4, but is not limited thereto.

The Target.Addr.Type item is allocated with 1 byte and represents the address type of the object node. In the exemplary embodiment of the present invention, when the present item represents 0x02, the Target.Addr item represents a shortening address of 2 bytes and when the present item represents 0x03, the Target.Addr item represents the expansion address of 8 bytes.

The Target.Addr item is allocated with 2 bytes or 8 bytes and represents the address of the object node. When the Target.Addr.Type item represents 0x02, the Target.Addr item represents the object node address of 2 bytes. On the other hand, when the Target.Addr.Type item represents 0x03, the Target.Addr item represents the object node address of 8 bytes.

The Orign.Addr.Type item is allocated with 1 byte and represents the address type of the source node. In the exemplary embodiment of the present invention, when the present item represents 0x02, the Orign.Addr item represents a shortening address of 2 bytes and when the present item represents 0x03, the Orign.Addr item represents the expansion address of 8 bytes.

The Orign.Addr item is allocated with 2 bytes or 8 bytes and represents the address of the source node. When the Orign.Addr.Type item represents 0x02, the Orign.Addr item represents the source node address of 2 bytes. On the other hand, when the Orign.Addr.Type item represents 0x03, the Orign.Addr item represents the source node address of 8 bytes.

The Orign.Seq item is allocated with 2 bytes and represents a serial number or a sequence number of messages.

The Orign.HopCnt item is allocated with 1 byte and represents the number of hops of the passing neighboring nodes. The present item is increased by 1 every time the RREP message moves from one node to another node.

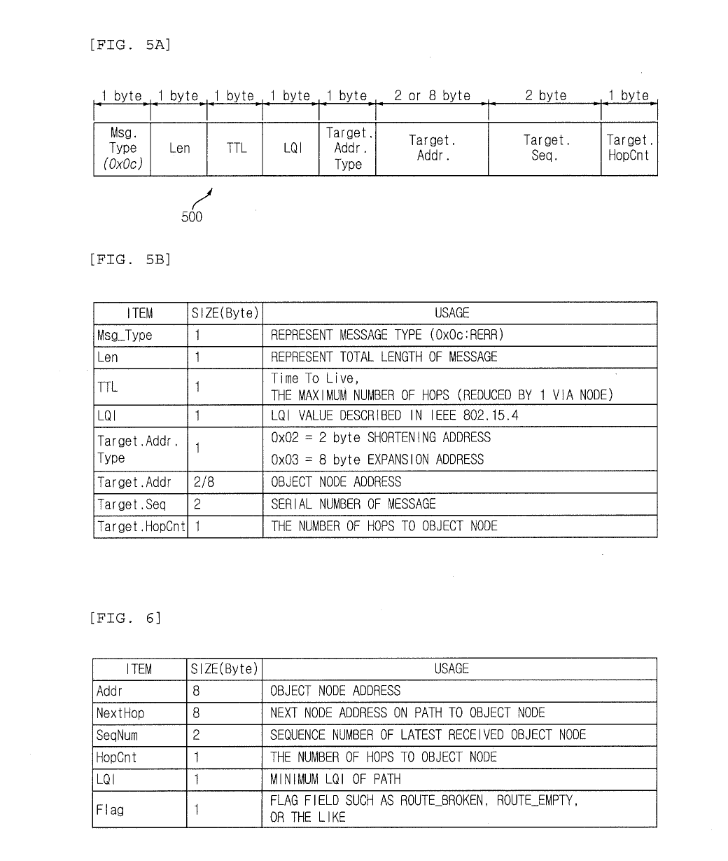

FIG. 5A is a diagram showing a data structure of a route error (RERR) message used in a routing protocol according to an exemplary embodiment of the present invention and FIG. 5B is a diagram for explaining each item of the RERR message according to an exemplary embodiment of the present invention.

As shown in FIG. 5A, an RERR message 500 according to the exemplary embodiment of the present invention includes a Msg_Type item, a Len item, a TTL item, an LQI item, a Target.Addr.Type item, a Target.Addr item, a Target.Seq item, and a Target.HopCnt item.

The Msg_Type item is allocated with 1 byte and represents a type of the corresponding message. In the case of the RERR message according to the exemplary embodiment of the present invention, the present item represents 0x0c.

The Len item is allocated with 1 byte and represents a total length of the corresponding message.

The time to live (TTL) item is allocated with 1 byte and represents the maximum number of hops of the corresponding message. The TTL item is reduced by 1 every time the corresponding message passes through each node.

The LQI item is allocated with 1 byte and means the LQI value. The exemplary embodiment of the present invention describes, for example, the LQI value described in IEEE 802.15.4, but is not limited thereto.

The Target.Addr.Type item is allocated with 1 byte and represents the address type of the object node. In the exemplary embodiment of the present invention, when the present item represents 0x02, the Target.Addr item represents a shortening address of 2 bytes and when the present item represents 0x03, the Target.Addr item represents the expansion address of 8 bytes.

The Target.Addr item is allocated with 2 bytes or 8 bytes and represents the address of the object node. When the Target.Addr.Type item represents 0x02, the Target.Addr item represents the object node address of 2 bytes. On the other hand, when the Target.Addr.Type item represents 0x03, the Target.Addr item represents the object node address of 8 bytes.

The Target.Seq item is allocated with 2 bytes and represents a serial number or a sequence number of messages.

The Target.HopCnt item is allocated with 1 byte and represents the number of hops of the passing neighboring nodes. The present item is increased by 1 every time the RERR message moves from one node to another node.

FIG. 6 shows a configuration of a routing table according to an exemplary embodiment of the present invention.

Hereinafter, the exemplary embodiment of the present invention will be described with reference to FIGS. 1 to 6.

A maximum of 10 routing table entries per each node may be used. Each path entry by which the object node 50 is searched uses a timer (not shown) and the brokened entry may be designed to be cancelled after a predetermined time.

As shown in FIG. 6, the routing table 145 according to the exemplary embodiment of the present invention includes an Addr item, a NextHop item, a SeqNum item, a HopCnt item, an LQI item, and a Flag item.

The Addr item is allocated with 8 bytes and represents the address of the object node.

The NextHop item is allocated with 8 bytes and represents the address of the next node on the path to the object node.

The SeqNum item is allocated with 2 bytes and represents a sequence number of the latest received object nodes. The present item may mean a sequence number of messages used to update the present routing table 600.

The HopCnt item is allocated with 1 byte and represents the number of hops to the object node.

The LQI item is allocated with 1 byte and represents the minimum LQI value of the path.

The Flag item is allocated with 1 byte and means a flag field such as ROUTE_BROKEN, ROUTE_EMPTY, or the like.

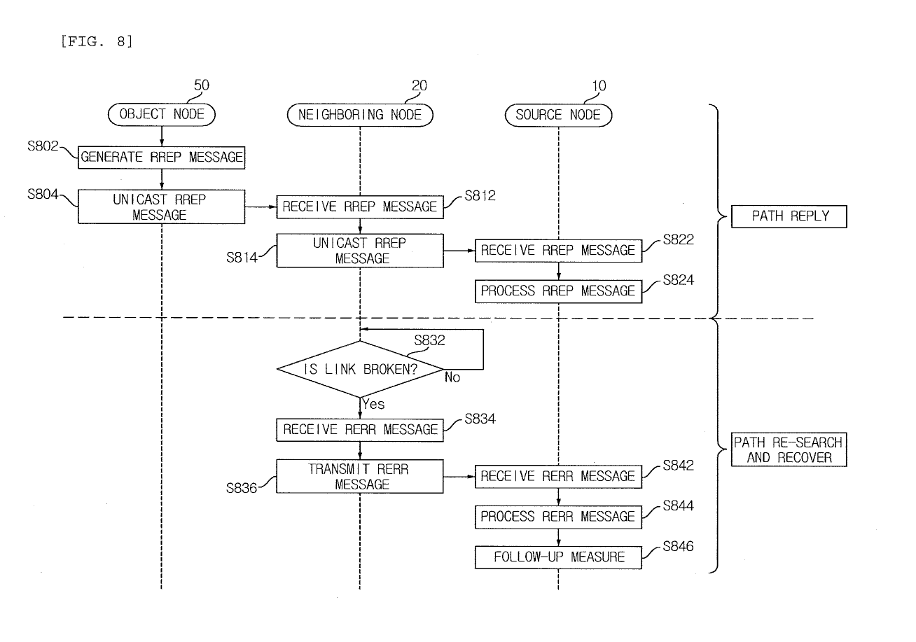

FIG. 7 is a flow chart for explaining a method of transferring the RREQ messages according to an exemplary embodiment of the present invention.

Similar to the exemplary embodiment of FIG. 1, in the exemplary embodiment of FIG. 7, a node denoted by reference numeral 10 as the source node, a node denoted by reference numeral 20 as the neighboring node, and a node denoted by reference numeral 50 as the object node are described by way of example.

Hereinafter, the exemplary embodiment of the present invention will be described with reference to FIGS. 1 to 7.

First, neighboring nodes are searched in the source node 10 (S702). An example of a search method may include a case of using link layer notification (LLN) information using ACK of IEEE 802.15.4, but the present invention is not limited thereto. Meanwhile, the LLN information may also be used in the link breakage search.

The RREQ message 300 is generated through the message generation unit 150 (S704). As described above, the RREQ message 300 is a message that searches the routing path for transferring predetermined data from the source node 10 to the object node 50.

The generated RREQ message 300 is broadcast to the neighboring nodes searched at step S702 through the message transmitting unit 180 (S706).

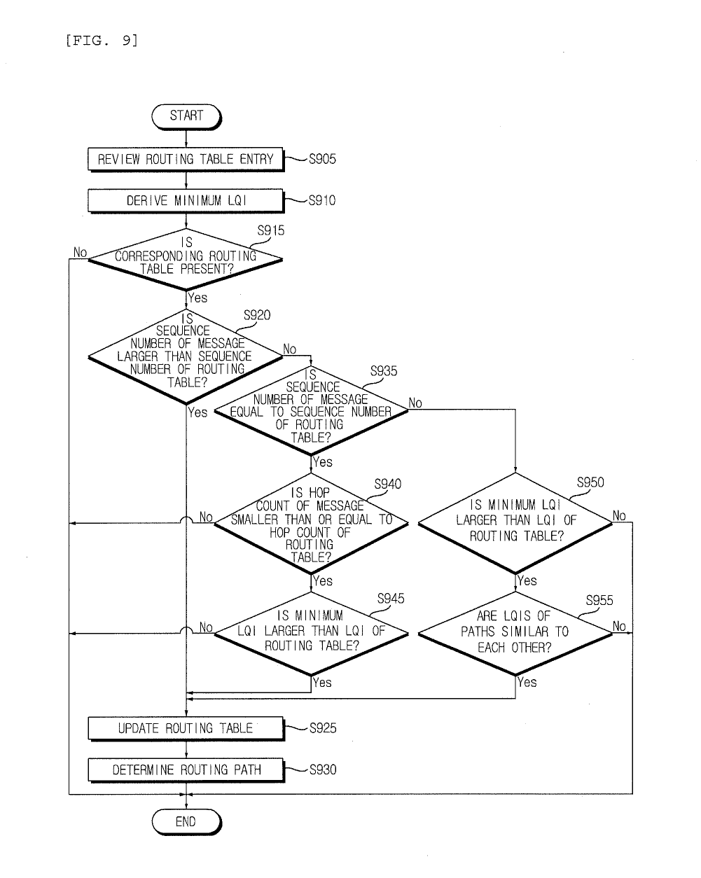

Meanwhile, in the neighboring node 20, the RREQ message 300 broadcast at the source node 10 is received through the message receiving unit 110 (S712) and the corresponding message is parsed through the message parsing unit 120. The information included in the parsed corresponding message is updated in the routing table 145 through the process as the exemplary embodiment of FIG. 9. The neighboring node 20 stores IDs of other neighboring nodes or the source node 10 transmitting the RREQ message 300 in the memory 140.

However, in the case of receiving the RREQ message 300 having the same sequence number from other nodes, when a second HopCnt item value that is the HopCnt item value included in the corresponding RREQ message 300 is larger than the previously received RREQ message, that is, a first HopCnt item value that is the HopCnt item value stored in the routing table (S714), the second HopCnt item included in the corresponding RREQ message 300 is used under the control of the control unit 170 to update the routing table 145 (S716).

On the other hand, when the second HopCnt item value is smaller than the HopCnt item value, the corresponding RREQ message is discarded (S722).

Under the control of the control unit 170, after the HopCnt item value within the corresponding RREQ message is increased by 1, the RREQ message is re-broadcast to other neighboring node 20 (S720).

When the RREQ message re-broadcasted from the neighboring node 20 is received at the object node 20 (S732), the object node 50 parses the RREQ message and is used to set the routing path by using the information on the RREQ message parsed through the message processing unit 130 (S734).

FIG. 8 is a flow chart for explaining a method of transferring the RREP messages and the RERR messages according to an exemplary embodiment of the present invention.

Similar to the exemplary embodiment of FIG. 1, in the exemplary embodiment of FIG. 8, a node denoted by reference numeral 10 as the source node, a node denoted by reference numeral 20 as the neighboring node, and a node denoted by reference numeral 50 as the object node are described by way of example.

Hereinafter, the exemplary embodiment of the present invention will be described with reference to FIGS. 1 to 8.

However, the exemplary embodiment of the present invention will separately describe a path reply process and path re-search and recovery process.

First, the path reply process will be described below. The object node 50 receiving the RREQ message generates the RREP message 400 through the message generation unit 150 (S802). As described above, the RREP message 400 is a message corresponding to the RREQ message 300.

The generated RREP message 400 is unicast to the source node 10 through the neighboring node 20 (S804). In this case, the RREP message is unicasted through a reverse path that is a reverse direction of the path through which the RREQ message is transferred. In this case, the information on the reverse path may use the identifier (ID) information of the node transmitting the RREQ message stored on the routing table 145.

The source node 10 receives the RREP message unicasted through the message receiving unit 110 (S822) and the received RREP message is processed through the message processing unit 130 (S824).

The path re-search and recovery process will be described as follows.

When the neighboring node 20 senses that the link on the routing path is broken (S832), the corresponding neighboring node 20 generates the RERR message 500 through the message generation unit 150 (S834). In this case, the link breakage at the neighboring node may use the LLN information using ACK of IEEE 802.15.4 as described above.

The corresponding neighboring node 20 reports the path error by transmitting the generated RERR message to the source node 10 through the message transmitting unit 180 (S836). In this case, the corresponding path information is cancelled in the routing table on an intermediate node (not shown) present during the report to the source node 10.

The source node 10 receives the RERR message 500 from the neighboring node 20 searching the link breakage from the neighboring node 20 or the intermediate node (not shown) between the neighboring node 20 and the source node 10 (S842). The source node 10 parses and processes the corresponding RERR message 500 (S844). In this case, since the source node 10 receives the report of the path breakage of the neighboring node 20, the search of the path through the RREQ message and the RREP message is again performed as follow-up measures (S846).

FIG. 9 is a flow chart for explaining the routing method according to an exemplary embodiment of the present invention.

The exemplary embodiment of the present invention will be described with reference to FIGS. 1 to 9.

When the message is received through the message receiving unit 110 of the sensor node 100, the corresponding sensor node 100 reviews the routing table entry stored in the memory 140 (S905).

The minimum LQI value is derived by the control unit 170 using a smaller value of the LQI value obtained by parsing the message and the LQI value of the message sensed in the signal strength sensing unit 115 for the received message (S910).

It is determined by the control unit 170 whether the corresponding routing table is present, based on the result of reviewing the routing table entry (S915).

As the determination result, when the corresponding routing table is present, the sequence number within the corresponding message is compared with the sequence number of the routing table under the control of the control unit 170 (S920).

As the comparison result, when the sequence number of the corresponding message is larger than the sequence number of the routing table, that is, when the corresponding message includes the more recent data than the routing table, the routing table is updated by the control unit 170 using the information obtained by parsing the corresponding message (S925).

The routing path of the message is determined by the control unit 170 using the updated routing table (S930). In this case, the routing path is determined by using the minimum LQI value.

Meanwhile, at step S920, when the sequence number of the message is not larger than the sequence number of the routing table, it is determined whether the sequence number of the message is identical with the sequence number of the routing table by the control unit 170 (S935).

At step S935, when it is determined whether the sequence number of the message is identical with the sequence number of the routing table, the hop count value within the message is compared with the hop count value the routing table under the control of the control unit 170 (S940).

As the comparison result at step S940, when the hop count value of the message is smaller than or equal to the hop count value of the routing table, it is compared whether the minimum LQI value derived at step S910 is larger than the LQI value of the routing table under the control of the control unit 170 (S945).

As the comparison result at step S945, when the minimum LQI value is larger than the LQI value of the routing table, the hop count value and the minimum LQI value of the message, and the like, are updated in the routing table under the control of the control unit 170 (S925). The routing path is determined by the updated routing table (S930).

Meanwhile, at step S935, when the sequence number of the message is smaller than the sequence number of the routing table, the minimum LQI value derived at step S910 and the LQI value of the routing table are compared with each other under the control of the control unit 170 (S950).

As the comparison result at step S950, when the minimum LQI value is larger than the LQI value of the routing table, it is determined whether the LQI values between the paths are similar to each other by the control unit 170 (S955). As the reference of determining whether the LQI values are similar to each other, when the difference in the minimum LQI value shown on at least two paths is smaller than the LQImax·ρLQI_DIFF value by defining a percentage value (ρLQI_DIFF) for the maximum LQI value actually measured, it is determined that the paths are similar to the LQI value.

As the result of determining whether the LQI values are similar to each other at step S955, when the LQI values between each path are not similar to each other, the minimum LQI value is updated in the routing table 145 by the control unit 170 (S925). In this case, the largest LQI value of the minimum LQI values is updated in the routing table 145.

The routing path is determined by the control unit 170 using the updated routing table (S930).

As the result of determining whether the LQI values are similar to each other at 5955, if the LQI values between each path are similar to each other, the path having the smaller number of hops among the paths is selected as the routing path by the control unit 170.

The multi hop routing apparatus and the multi hop routing method according to the exemplary embodiment can be applied to any method of setting the routing path transmitting and receiving the data between the sensor nodes on the radio sensor network.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A multi hop routing apparatus, comprising:
a receiving unit that receives multi hop routing messages;
a parsing unit that parses the received multi hop routing messages; and
a control unit that performs a control to determine a routing path using a hop count value and a link quality indicator (LQI) value included in the parsed multi hop routing message.

2. The apparatus of claim 1, wherein the multi hop routing message includes an item defining a message type, an item representing a total length of a message, an item representing the maximum number of hops, an item representing a link quality indicator, an item representing an address of an object node, an item representing an address of a source node, a sequence number item, and a hop count item representing the number of hops of the passing node.

3. The apparatus of claim 1, wherein the multi hop routing message is any one of a route request (RREQ) message, a route reply (RREP) message, and a route error (RERR) message.

4. The apparatus of claim 1, further comprising: a memory that stores a routing table in which the hop count value and the link quality indicator value are included.

5. The apparatus of claim 4, wherein the control unit performs a control to update the routing table using information included in the multi hop routing message when a sequence number included in the multi hop routing message is larger than a sequence number of the routing table.

6. The apparatus of claim 4, wherein the control unit performs a control to update the routing table using the information included in the multi hop routing message when a value of the hop count item of the multi hop routing message is smaller than or equal to the hop count value of the routing table.

7. The apparatus of claim 4, wherein the receiving unit senses signal strength at the time of receiving the multi hop routing message to derive the link quality indicator value, and
the control unit compares the sensed LQI value with the link quality indicator value included in the multi hop routing message to derive the minimum link quality indicator value.

8. The apparatus of claim 7, wherein the control unit updates the routing table using the minimum link quality indicator value when the minimum link quality indicator value is larger than the link quality indicator value included in the routing table.

9. The apparatus of claim 7, wherein the control unit compares the hop count values on each routing path to perform a control to select the routing path having the small hop count when each minimum link quality indicator value on at least two routing paths is in a predetermined range.

10. The apparatus of claim 4, wherein the routing table includes an item representing an address of an object node, a next node address item on a path to the object node, a hop count item to the object node, and an item representing a minimum link quality indicator, the item including a smaller link quality indicator value as a result of comparing the link quality indicator value based on signal strength sensed at the time of receiving the multi hop routing message and the link quality indicator value included in the multi hop routing message.

11. A multi hop routing method routing in a sensor node, comprising:
receiving multi hop routing messages;
parsing the received multi hop routing messages;
setting a smaller value of link quality indicator values to a minimum link quality indicator value based on signal strength when receiving the link quality indicator (LQI) value included in the parsed multi hop routing message and the multi hop routing message; and
setting a routing path using the minimum link quality indicator value when the minimum link quality indicator value is larger than the link quality indicator value included in a routing table on the sensor node.

12. The method of claim 11, further comprising:
determining whether the hop count value of the multi hop routing message is smaller than or equal to the hop count value of the routing table,
wherein the setting is performed if it is determined that the hop count value of the multi hop routing message is smaller than or equal to the hop count value of the routing table.

13. The method of claim 11, wherein the setting includes:
determining whether each minimum link quality indicator value on at least two routing paths is in a predetermined range when the minimum link quality indicator value is larger than a link quality indicator value included in the routing table on the sensor node; and
selecting the routing path having a smaller hop count by comparing the hop count values on each routing path if it is determined that each minimum link quality indicator value on at least two routing paths is in a predetermined range.
